(19) United States
(12) Patent Application Publication
(10) Pub. No.: US 2024/0100739 A1
(43) Pub. Date: Mar. 28, 2024

(54) PREFORM PRODUCED BY KNITTING, COMPOSITE PRODUCT INCORPORATING SUCH A PREFORM AND MANUFACTURING METHODS

(71) Applicant: SAINT-GOBAIN PERFORMANCE PLASTICS FRANCE, CHARNY OREE DE PUISAYE (FR)

(72) Inventors: Gaëtan MAO, PESSAC (FR); Nicolas DUMONT, GRADIGNAN (FR)

(21) Appl. No.: 18/550,868

(22) PCT Filed: Mar. 14, 2022
(86) PCT No.: PCT/FR2022/050452

§ 371 Date: Sep. 15, 2023

(30) Foreign Application Priority Data
Mar. 16, 2021 (FR) 2102590

(51) Int. Cl. B29B 11/16; D04B 1/16

(52) U.S. Cl. CPC B29B 11/16; D04B 1/16; D10B 2401/041; D10B 2403/033; D10B 2505/02

(57) ABSTRACT

A pre-consolidated preform produced by knitting, the preform being intended for the manufacture of composite products, this preform being formed of a knit fabric including at least one polymeric material and at least one yarn of at least one reinforcing material, the knit fabric including a polymeric material P1 constituting less than 20% by volume of the knit fabric or of the pre-consolidated preform and serving as adhesive in the pre-consolidated preform.

The present invention relates to a preform produced by knitting, said preform being intended for the manufacture of composite products, as well as a composite product obtained from such a preform. The present invention also relates to a method for manufacturing such a preform, as well as a method for manufacturing a composite product from such a preform.

The composites products (or “pieces”) considered in the present invention are products comprising a matrix (generally the main constituent of the product, wherein the other constituents are contained) in particular based on a polymeric material, in particular and preferably a thermoplastic one in the present invention, this matrix being reinforced by a material generally having a higher melting or degradation temperature than the temperature at which said matrix is produced from said polymeric material (for example greater than the melting temperature of said polymeric material). Composite products incorporating a polymeric matrix and a reinforcing material are well known and make it possible to achieve interesting effects or better properties than products formed from said polymeric material alone, such as improved properties in terms of mechanical strength or corrosion resistance, or even making the pieces more lightweight, etc.

The reinforcing matter (or the material) incorporated into the matrix may be in the form of discrete or continuous elements, for example in the form of fibers that are dispersed in the matrix or in the form of yarns or fibers which are preassembled into fabrics, nonwovens, mats or other products obtained by textile processes, or may be in the form of frame(s), etc.

The use of woven reinforcements (or strands of reinforcing yarns) is particularly common, in particular woven reinforcements pre-impregnated with polymeric material (or “prepreg”). These fabric reinforcements are traditionally formed of weft yarns and warp yarns arranged perpendicularly, and conventionally have a flat structure. In order to obtain a three-dimensional (or 3D) product, the fabrics are generally cut and arranged in a mold, the general shape of which corresponds to that of the piece to be produced, the polymeric material (or resin) then being injected and polymerized in the mold in order in particular to give a rigid piece.

More recently, there appeared knit fabrics incorporating a polymeric material and reinforcing yarns or reinforcing fibers, these knit fabrics generally being obtained from a continuous yarn (which may be mono or multi-filament and/or formed of discontinuous fibers bonded for example by twisting or wrapping, etc.), this yarn forming interlaced stitches arranged in successive rows, the reinforcing material being able for example to be present in the stitch yarn(s) or which may be part of weft yarns added to the knit fabric in the form of unidirectional yarns. Different knitting techniques (in particular circular or flat) make it possible in particular to obtain knit fabrics forming a unitary 2D or 3D piece, without stitching.

These knitted reinforced structures have many advantages compared to woven reinforced structures. In fact, in addition to the possibility of initially producing a 3D reinforced structure in one piece without stitching, knitting may be done if appropriate from a single spool of yarn for the stitch yarn, while fabrics still require several distinct spools. Furthermore, while the draping of reinforced structures woven on a mold is a lengthy and delicate operation, in particular when the desired shape is complex, requiring the use of several layers of fabric that must be cut (with product losses that may represent 30% of the material) and judiciously arranged according to the shape of the mold in order to ensure sufficient thickness while avoiding too much overlap and requiring the addition of reinforcing pieces locally to ensure that mechanical strength is preserved, this preservation being imperfect since the fibers are not continuous, 2D or 3D knitting makes it possible to produce a complex product, which may, if appropriate, be draped directly on a 2D or 3D shape and ensure the continuity of the yarns throughout the product obtained, the knit fabric, already having a shape that is adapted to obtain the desired product, not needing, for instance, to be positioned around a flexible substrate such as a silicon bladder, the whole assembly then being placed in a mold to achieve the consolidation in a vacuum that allows the finished product to be obtained.

The woven reinforced structures pre-impregnated with polymeric material (for example gelled) most commonly used must also be delicately handled, these structures being tacky when the protective film is removed, and remaining usable only for a limited period of time at room temperature. Conversely, knitting makes it possible to integrate the polymeric material in the form of yarns or fibers mixed with the reinforcing yarns or fibers and to obtain a preform (intermediate/temporary form before the final form) called “dry”, containing both the reinforcement(s) and the matrix.

For example, patent application FR 3065181 of the patent holder discloses a method for producing a dry preform for manufacturing a product made of composite materials. This document describes a preform made by knitting and integrating at least one unidirectional reinforcing yarn, this preform no longer requiring the injection of a resin because it is constituted as soon as a mixture of yarns or filaments made of reinforcing material and yarns or filaments made of thermoplastic material is knit, the thermoplastic yarns being intended to melt during shaping.

Preforms produced by knitting still have certain drawbacks. Thus, it may be difficult to manipulate this flexible product for an inexperienced user or to transport it unaltered from its place of production to where the composite product is manufactured. In addition, for certain high technical products (in the field for example of aeronautics, automotive, construction, etc.), that particularly require the use of polymeric material with a high melting point, in particular greater than 200° C., the consolidation of knit fabrics incorporating such a material using, for example, the vacuum method using a flexible substrate in the form of a silicone bladder is no longer possible because of the more rapid degradation or wear of said bladder beyond 180-200° C. Adopting another method such as that used for fabrics in order to produce these products is not satisfactory nor suitable for these more deformable structures, the knit fabrics provided with unidirectional reinforcing yarn(s) or fiber(s) that must then be superposed, varying their orientation in the mold, but still being capable of moving relative to one another during molding, thus changing the orientation of the reinforcing yarn(s) or fiber(s) and potentially forming wrinkles that cannot be removed without damaging said yarn(s) or fiber(s).

The present invention therefore sought to remedy the above drawbacks and to propose a more satisfactory, production of textile product (formed of structuring and reinforcing yarn(s) or fiber(s)), with improved design and implementation for the manufacture of composite products, in particular intended for highly technical applications using high melting points, for example for composite pieces intended for aeronautics or for use in the field of radio frequencies (in particular for the manufacture of radomes, etc.).

This objective has been achieved by virtue of the pre-consolidated preform produced by knitting, said preform being intended for the manufacture of a composite product, this preform being formed of at least one knit fabric comprising at least one polymeric material and at least one yarn of at least one reinforcing material, said knit fabric comprising a thermoplastic polymeric material P1 constituting less than 20% by volume of said knit fabric or of said pre-consolidated preform and serving as adhesive in said pre-consolidated preform.

The present invention also relates to a method for producing (or manufacturing) a pre-consolidated preform intended for the manufacture of a composite product, said method comprising the following steps:
a) producing at least one preform formed of at least one knit fabric by knitting from at least one continuous yarn, this knit fabric comprising one or more thermoplastic polymeric materials and comprising at least one yarn of at least one reinforcing material, the thermoplastic polymeric material P1 having a lower melting point T1 representing less than 20% by volume of said knit fabric or of said preform,
b) depositing the preform formed of at least said knit fabric in or on a mold or a substrate,
c) melting the polymeric material P1 with the lowest melting point T1 to a temperature greater than or equal to the melting point T1, this temperature being, where appropriate, in the event of the presence of another thermoplastic polymeric material, in particular intended to form the matrix of said composite product, less than the melting point of said other material, in order to allow only the melting of the polymeric material P1,
d) cooling the preform to obtain the pre-consolidated preform, the polymeric material P1 with the lowest melting point T1 then serving as adhesive.

The present invention also relates to a method for manufacturing a composite product from a pre-consolidated preform, this method comprising the following steps:
depositing in a mold of at least one pre-consolidated preform formed by at least one knit fabric comprising one or more thermoplastic polymeric materials and at least one yarn of at least one reinforcing material, said knit fabric or said preform comprising a thermoplastic polymeric material with melting point T1 constituting less than 20% by volume of said knit fabric or of said preform and serving as adhesive in said pre-consolidated preform, said knit fabric optionally comprising at least one other polymeric material with a melting point greater than T1,
optionally impregnating with another polymeric material than the material P1,
treating or consolidating said pre-consolidated preform, impregnated where appropriate, having at least said polymeric material with melting point T1, another polymeric material intended to form the matrix of the composite product and at least one yarn of at least one reinforcing material, this treatment or this consolidation being carried out either, particularly in the case where the other polymeric material is thermoplastic, at a temperature greater than or equal to the melting point of this other material, or, particularly in the case where the other polymeric material is thermosetting, by curing said material, to obtain said composite product,
cooling the composite product thus obtained.

The present invention also relates to a method for manufacturing a composite product from a knit fabric, this method comprising the following steps:
a) producing at least one preform formed of at least one knit fabric by knitting from at least one continuous yarn, this knit fabric comprising one or more thermoplastic polymeric materials and comprising at least one yarn of at least one reinforcing material, the thermoplastic polymeric material having a lower melting point T1 representing less than 20% by volume of said knit fabric or of said preform,
b) depositing the preform formed of at least said knit fabric in or on a mold or a substrate,
c) melting the polymeric material P1 with the lowest melting point T1 to a temperature greater than or equal to the melting point T1, this temperature being, where appropriate, in the event of the presence of another thermoplastic polymeric material, less than the melting point of said other polymeric material, in order to allow only the melting of the polymeric material P1 with the lower melting point,
d) cooling the preform to obtain the pre-consolidated preform, the polymeric material P1 with the lowest melting point T1 then serving as adhesive,
e) depositing at least said pre-consolidated preform into a mold,
f) optionally impregnating with another polymeric material than the material P1,
g) the treating or consolidating said pre-consolidated preform, impregnated where appropriate, having at least said polymeric material with melting point T1, another polymeric material intended to form the matrix of the composite product and at least one yarn of at least one reinforcing material, this treatment or this consolidation being carried out either, particularly in the case where the other polymeric material is thermoplastic, at a temperature greater than or equal to the melting point of this other material, or, particularly in the case where the other polymeric material is thermosetting, by curing said material, to obtain said composite product,
h) cooling the composite product thus obtained.

The invention also relates to a knit fabric intended for the manufacture of composite product(s), comprising at least one thermoplastic polymeric material P2 having a melting point T2, this polymeric material P2 being in particular intended to form the matrix of a composite product, at least one polymeric material P1 having a melting point T1 lower than the melting point T2, intended in particular to serve as adhesive, the polymeric material P1 constituting less than 20% by volume of said knit fabric or of said preform, and at least one reinforcing material, the material P1 in particular forming one or more yarns of said knit fabric or of said preform.

Finally, a composite product, in particular a piece intended for aeronautics or to be used in the radiofrequency field, such as a radome, obtained by the method according to the invention and/or from the pre-consolidated preform according to the invention, said product comprising at least one polymeric material P2, forming the matrix of said composite, and comprising at least one yarn of at least one reinforcing material, and at least one polymeric material P1 representing less than 10% by volume of said product also made it possible to achieve this objective.

The present invention therefore proposes a pre-consolidated preform made by knitting and intended for the manufacture of a composite product, said preform being formed of at least one knit fabric (or being formed from at least one knit fabric or comprising at least one knit fabric), said knit fabric comprising at least one polymeric material and at least one yarn of at least one reinforcing material, said knit fabric comprising a thermoplastic polymeric material P1 constituting (or representing) less than 20% by volume of said knit fabric or of said pre-consolidated preform, and serving as adhesive in said pre-consolidated preform, this material P1, incorporated in particular during the knitting and/or initially forming yarns of the knit fabric, in particular binding the yarn(s) of the knit fabric with one another in the pre-consolidated preform after having been melted (and therefore being in a form other than a form of yarn(s) in said pre-consolidated preform), in particular in the form of beads of adhesive or coating(s) on the surface of yarn(s) of the knit fabric (and not in the form of yarn(s)) within said pre-consolidated preform.

The term “yarn(s)” is used in the present invention to denote yarn(s) and/or fiber(s) used to produce knit fabrics (in particular stitch or weft yarns), these yarns being able to be mono or multi-filament(s) and/or formed of discontinuous fibers bonded, for example, by twisting or wrapping, these yarns being in particular continuous yarns (as opposed to cut or short fibers) in order to allow their stitch knitting or weft insertion in one or the other dimension (width or length) of the knit.

The term “preform” is understood to mean a textile product (that is, formed of intermediate yarn(s) or fibers) (intended to be transformed to form a final product), having a temporary shape approaching the shape of the composite product to be produced, this temporary form being in particular and preferably according to the invention a 3D shape (thick and flat or non-flat), this textile product being in the present invention obtained by knitting (or from knit(s)), more specifically by knitting at least one continuous yarn where the yarn forms interlaced stitches, arranged in successive rows. Said preform is called “dry” (as opposed to sticky pre-impregnated fabrics), and as appropriate constitutes the skeleton of the composite product produced, this preform in particular incorporating reinforcements (more precisely reinforcing yarns formed of at least the aforementioned reinforcing material) and a material intended to form all or some of the final matrix of the composite

The preform can be formed of (or made up of only) one or more knit fabrics (also called “plies” in the preform), the pre-consolidated preform being a more rigid (and easier to handle) shape of the preform (that is, more rigid than the initial preform formed solely of a knit fabric or of an assembly of knit fabrics).

The knitted structure(s) according to the invention (knit fabric, preform, pre-consolidated preform) according to the invention incorporates one or more polymeric materials, including at least the thermoplastic material P1, intended to undergo a change of state, in particular to melt, and to form or to be part (in this changed state) of the matrix of the intended composite product, and at least one material intended to serve as reinforcement (and in particular not to be melted) in the intended composite, this reinforcing material (or, if appropriate, each of the reinforcing materials present) forming one or more yarns of the knitted structure, and having a phase change temperature T_{R} greater than the phase change temperature of said or of each of said aforementioned polymeric materials. The composite product corresponds to the definitive shape, in particular a fixed shape, obtained by final consolidation of the pre-consolidated preform and comprising a polymeric matrix in which the reinforcements/reinforcing materials (or reinforcing yarns formed of at least the aforementioned reinforcing material) are embedded, the polymeric matrix generally being predominant as specified below.

The expression “change of state” (or phase) temperature is understood to mean (at/for a given pressure) the temperature at which the material undergoes a change of shape (in particular with respect to its shape in the initial knit fabric) such as going from solid to liquid, or decomposition or degradation. In particular, for a thermoplastic polymeric material, this is (at a given pressure) the temperature at which or from which (when the melting takes place over a temperature range, in the case of a mixture of molecules for example) the material melts (changes from solid to liquid), this temperature commonly being called the melting temperature (or melting point). For a thermosetting polymeric material or a reinforcing material, it may in particular be (at a given pressure) the melting temperature, at which or from which the material goes from solid to liquid, or the degradation temperature, at which the material degrades (or decomposes or burns or calcines), or, where appropriate, the lower of these temperatures (melting or degradation). These relative temperatures (considered relative to one another for the different materials) are considered at identical pressure, in particular the pressure at which the final consolidation of the composite must be carried out, or optionally, by default, at normal atmospheric pressure (1 atmosphere).

Preferably, according to the invention, all the polymeric materials present in the knitted structure according to the invention (whether referring to the knit fabric, the preform or the pre-consolidated preform) are thermoplastic materials, the phase change temperature of each of these polymeric materials in this case being their melting temperature,

In a particularly advantageous preferred embodiment, the knitted structure according to the invention (whether referring to the knit fabric, the preform or the pre-consolidated preform) comprises at least one (other) polymeric material P2, in particular a thermoplastic polymeric material, particularly forming (alone or in combination as specified below) at least one yarn of said structure, this material P2 having a phase change temperature, in particular a melting temperature, T2, this polymeric material P2 being in particular intended to melt during production of the composite so as to obtain the fixed final shape of said composite, this material then forming the matrix of said composite, the polymeric material serving as adhesive P1 being a different polymeric material (in particular with a different melting point) from the polymeric material P2 and having a melting point T1 (strictly) lower (preferably at least 20° C. lower, or even at least 50° C.) than the phase change temperature (in particular melting) T2, the phase change temperature T_{R} of the reinforcing material being greater than said respective temperatures T2, and more so than T1.

The present invention thus relates in a preferred embodiment to a pre-consolidated preform produced by knitting, intended for the production of a composite product, this preform being formed of at least one knit fabric comprising at least one thermoplastic polymeric material P2 (in particular forming or in the form of at least one continuous yarn) having a melting point T2, this polymeric material being in particular intended to form the matrix of said composite, and this knit fabric comprising at least one polymeric material P1 with a melting point T1 less than the melting point T2, this material P1 having in particular been incorporated during the knitting and/or initially forming yarns of the knit fabric, this polymeric material P1 serving as adhesive within said pre-consolidated preform, and constituting less than 20% by volume of said knit fabric or of said pre-consolidated preform, said preform also comprising at least one yarn of at least one reinforcing material(s) (or reinforcing yarn), this reinforcing material(s) having a phase change temperature T_{R} greater than T2, this material being intended to serve as reinforcement (and in particular not to be melted) in said composite.

In this preferred embodiment, the two polymeric materials, the material P2 in particular forming one or more yarns of the knit fabric and of the preform and intended to form the matrix or the essential part of the matrix of the future composite product, and the minority polymeric material P1 intended to bond the yarn(s) of the knit fabric together in the pre-consolidated preform until said composite product is produced, are both parts of the pre-consolidated preform, and where appropriate of the initial knit fabric forming the preform.

This advantageous knit fabric, where appropriate in three dimensions, intended to form the aforementioned pre-consolidated preform in order to subsequently produce a composite product, and which thus initially integrates the three aforementioned materials (three-component knit fabric) is also considered in the present invention, as well as the preform (three-component preform) formed from said knit fabric (and, where appropriate, incorporating several other knit fabrics or plies, in particular similar or identical, superposed while if necessary changing the orientation of the reinforcement yarn(s)), this knit fabric or this preform made by knitting thus comprising at least one thermoplastic polymeric material P2 having a melting point T2, this polymeric material P2 being in particular intended to form the matrix of said composite, at least one (second/other) polymeric material P1, with melting point T1 less than the melting point T2, intended in particular to serve as adhesive in the pre-consolidated preform intended to be produced from said knit fabric/preform, the polymeric material P1 constituting less than 20% by volume of said knit fabric/preform, said knit fabric or said preform also comprising at least one reinforcing material, having in particular a phase change temperature (where appropriate a melting temperature) T_{R} greater than T2. In this knit fabric or this preform (not yet consolidated), the material P1 may in particular form one or more yarns, in particular alone or within a mixed yarn or else in the form of wrapping or sheathing a yarn of another material, as explained below.

In another embodiment described more specifically in relation with the method for producing the composite product according to the invention, the polymeric material P2 intended to form (most of) the matrix of said composite is incorporated subsequently into the preform, which where appropriate is already pre-consolidated, in particular is added to the pre-consolidated preform during the production of the composite, in a form other than a yarn form, in particular is added by impregnating said preform/knit fabric by (or with) said polymeric material P2

The present invention also proposes a method for manufacturing (or producing or obtaining) a pre-consolidated preform for (or intended for) manufacturing a composite product, said method comprising the following steps (or operations or actions):
a) producing at least one preform formed of at least one knit fabric, in particular in three dimensions and in a continuous piece whose shape matches (or approaches) the shape of the composite product to be obtained, by knitting from at least one continuous yarn, this knit fabric comprising one or more thermoplastic polymeric materials (in particular at least one yarn of at least one thermoplastic polymeric material) and comprising at least one yarn of at least one reinforcing material, having in particular a phase change temperature T_{R} greater than that of the polymeric material(s) present, (the content of) the thermoplastic polymeric material P1 of lower melting point T1 representing less than 20% by volume of said knit fabric or of said preform,
b) depositing (or draping) the preform formed by at least said knit fabric in or on a mold (or a mold part) or a substrate,
c) (pre-consolidation by) melting (at least partially) of the polymeric material P1 with the lowest melting point T1, in particular by treatment/curing (in particular heating under pressure) to a temperature greater than or equal to the melting point T1 and less than the phase change temperature T_{R}, this treatment temperature being, where appropriate, in the event that another thermoplastic material (or any other thermoplastic polymeric material) is present in the knit fabric or preform, in particular a material P2 with a melting point T2 greater than T1 (and less than T_{R}) intended to form the matrix of the intended composite product, lower than the melting point T2 of the polymeric material P2, to allow only the melting of the polymeric material P1 with the lowest melting point,
d) cooling the preform to obtain the pre-consolidated preform, the polymeric material P1 with the lowest melting point T1 then serving as adhesive.

The expression “thermoplastic polymeric material P1 with the lowest melting point T1” means that the melting point is the lowest compared with that of any other thermoplastic material that may be present in the knit fabric or the preform, in particular relative to any other thermoplastic polymeric material P2 intended to form the matrix of the desired composite product, whether this material P2 is present in the knit fabric or even added subsequently during the production of the composite. If this material P1 is the only polymeric material present in the knit fabric or the preform, it is also in a sense the lowest (no other material with a lower melting point), and in particular is lower than the phase change temperature of the reinforcing material.

If necessary, when the preform comprises several assembled (in particular superposed) knit fabrics, step a) can be broken down into a first step a₁) producing one or more knit fabrics by knitting from at least one continuous yarn, each knit fabric comprising one or more thermoplastic polymeric materials (in particular at least one yarn of at least one thermoplastic polymeric material) and comprising at least one yarn of at least one reinforcing material, having in particular a phase change temperature T_{R} greater than that of the polymeric material(s) present, the thermoplastic polymeric material P1 with the lowest melting point T1 of each of the knit fabrics representing less than 20% by volume of said knit fabric, and a step a₂) of assembly (in particular by superposing) several knit fabrics (in particular identical or similar, each obtained by knitting, in particular according to step a₁) for at least some or all of them) to form the preform.

The deposition of step b) can also, where appropriate, depending on the intended type of composite product and type of molding, be preceded by or consist of a step of draping around a substrate, for example flexible such as a silicone bladder, the assembly optionally being deposited in or on a mold.

The treatment or heating of step c) can be carried out (and is generally carried out) over the whole of the preform within the mold (formed of a rigid piece and a second part, or counter-mold, which is flexible or rigid, the treatment being carried out if appropriate in a vacuum, as detailed below), or optionally may be carried out locally at different points of the preform (for example using local heating means), the melting of the thermoplastic material P1 possibly occurring in a more or less total or general or even partial manner (at certain points or in a certain volume in particular).

The cooling of step d) can be carried out by allowing cooling to occur naturally or by accelerating the cooling.

In the preferred embodiment mentioned above, wherein the knit comprises two thermoplastic polymeric materials, in particular a material P2, forming in particular one or more yarns of the knit fabric, and intended to form the matrix or most of the matrix of the future composite product, and a polymeric material P1 (with a lower melting point) which is the material intended to bond the yarn(s) of the knit fabric to one another in the pre-consolidated preform (this material may also be in the form of yarn(s) in the knit fabric where appropriate), the method for manufacturing the preceding preform then comprises the following steps:
a) producing at least one preform formed of at least one knit fabric by knitting from at least one continuous yarn, this knit fabric comprising at least one thermoplastic polymeric material P2 (in particular in the form of at least one yarn) having a melting point T2, and comprising at least one yarn of at least one reinforcing material having in particular a phase change temperature T_{R} greater than T2, and this knit fabric comprising at least one thermoplastic polymeric material P1 with a melting point T1 lower than the melting point T2, said polymeric material P1 representing less than 20% by volume of said knit fabric or of said preform:
b) depositing the preform formed of at least said knit fabric in or on a mold or a substrate,
c) melting the polymeric material P1, in particular by treatment (in particular heating under pressure) at a temperature greater than or equal to T1 and less than T2, in order to allow only the melting of the polymeric material P1, and not of the material P2,
d) cooling the preform to obtain the pre-consolidated preform, the polymeric material P1 with the lowest melting point T1 then serving as adhesive.

The present invention also proposes a method for manufacturing a composite product, comprising a matrix made of polymeric material(s) reinforced by reinforcing yarns (or reinforcement yarns), the polymeric material(s) having a melting point lower than the phase change temperature of the material constituting the reinforcement yarns, from a pre-consolidated preform according to the invention, this method comprising the following steps:
depositing in a mold at least said pre-consolidated preform as previously defined according to the invention, this preform being formed of at least one knit fabric comprising one or more thermoplastic polymeric materials and at least one yarn of at least one reinforcing material, having in particular a phase change temperature T_{R} greater than that of the polymeric material(s), said knit fabric or said preform comprising a thermoplastic polymeric material P1 with a melting point T1 constituting less than 20% by volume of said knit fabric or of said preform and serving as adhesive in said pre-consolidated preform, said knit fabric optionally comprising at least one other polymeric material with a melting point greater than T1,
optionally impregnating with another polymeric material than the material P1, in particular at least one polymeric material with a melting point greater than T1, in particular in the event of an insufficient or absent proportion of polymeric material(s) other than P1 in the knit fabric to obtain the matrix of said composite
treating, if appropriate by heating under pressure, or consolidation of said pre-consolidated preform, impregnated where appropriate, having at least said polymeric material with melting point T1, another polymeric material intended to form the matrix of the composite product and at least one yarn of at least one reinforcing material, this treatment or this consolidation being carried out either, particularly in the case where the other polymeric material is thermoplastic, at a temperature greater than or equal to the melting point of this other material (and less than the phase change temperature of the reinforcing material T_{R}), or, particularly in the case where the other polymeric material is thermosetting, by curing said material (this curing can occur depending on the material at room temperature or by heating), to obtain said composite product,
cooling the composite product thus obtained.

The consolidation may be carried out by curing in the case of certain liquid thermoplastic resins.

Preferably, in the present invention, the level of polymeric material P1 in the composite, carried out in particular by this method, is less than 10% by volume of said composite product, in particular is less than or equal to 5%.

The method for producing the composite product from the fabric or the initial preform (not pre-consolidated) also incorporates the steps a) to d) of manufacturing the pre-consolidated preform mentioned above and then comprises the following operations:
a) producing at least one preform formed of at least one knit fabric by knitting from at least one continuous yarn, this knit fabric comprising one or more thermoplastic polymeric materials and comprising at least one yarn of at least one reinforcing material, the thermoplastic polymeric material having a lower melting point T1 representing less than 20% by volume of said knit fabric or of said preform,
b) depositing the preform formed of at least said knit fabric in or on a mold or a substrate,
c) melting the polymeric material P1 with the lowest melting point T1 to a temperature greater than or equal to the melting point T1 (and less than the temperature T_{R}), this temperature being, where appropriate, in the event of the presence of another thermoplastic polymeric material, in particular intended to form the matrix of said composite product, less than the melting point of said other polymeric material, in order to allow only the melting of the polymeric material with the lowest melting point P1,
d) cooling the preform to obtain the pre-consolidated preform, the polymeric material P1 with the lowest melting point T1 serving as adhesive in such circumstances,
e) depositing at least said pre-consolidated preform into a mold,
f) optionally impregnating with another polymeric material than the material P1, in particular with at least one polymeric material with a melting point greater than T1, in particular in the event of an insufficient or absent proportion of polymeric material(s) other than P1 in the knit fabric to obtain the matrix of said composite,
g) treating or consolidating said pre-consolidated preform, impregnated where appropriate, having at least said polymeric material with melting point T1, another polymeric material intended to form the matrix of the composite product and at least one yarn of at least one reinforcing material, this treatment or this consolidation being carried out either, particularly in the case where the other polymeric material is thermoplastic, at a temperature greater than or equal to the melting point of this other material, or, particularly in the case where the other polymeric material is thermosetting, by curing said material, to obtain said composite product,
h) cooling the composite product thus obtained.

Optionally, when the knit fabric or the preform already comprises a polymeric material P2 in addition to the material P1, the step of impregnation with a polymeric material in the method for producing the composite according to the invention can also allow the introduction of a third material P3, intended for example to form an overmolding depending on the desired type of composite product.

The present invention also relates to a composite product, obtained in particular according to the preceding method and/or from the pre-consolidated preform previously described, in particular in three dimensions, this composite product comprising at least one (first) polymeric material P2, in particular thermoplastic, having, where appropriate, a melting point T2 and forming the matrix of said composite, and comprising at least one yarn of at least one reinforcing material, having in particular a phase change temperature T_{R} greater if appropriate than T2, this material serving as reinforcement in said composite, and at least one (second) thermoplastic polymeric material P1, whose melting point T1, is lower if appropriate than the melting point T2, this material P1 representing in particular less than 10% by volume of said product.

Advantageously, this composite product is a piece intended for aeronautics or to be used in the radiofrequency domain, such as a radome.

As previously seen, the polymeric material intended to form the matrix or the bulk of the matrix of the composite considered is called “P2”. It is either already present in the initial knit fabric, in particular in the form of at least one yarn forming the stitches of the knit fabric, or added later, in particular by impregnating the pre-consolidated preform with said material P2 during the formation of the composite. The polymeric material serving as adhesive is called P1, and is part of the initial knit fabric, this material being able to be in different forms (yarn(s), wrapping, sheathing, etc.) as detailed subsequently.

As previously indicated, the preform according to the invention is formed of at least one knit fabric comprising at least one polymeric material and at least one yarn of at least one reinforcing material. In one of the embodiments cited above, the knit fabric is formed, as polymeric material(s), solely of the polymeric material P1, which, in the initial knit fabric, is then in the form of at least one yarn (of said material P1 or optionally mixed with the reinforcing material, or by wrapping or sheathing the reinforcement yarns) forming the stitches of the knit fabric and/or weft yarns, and which, in the pre-consolidated preform, is then in molten form (for example beads of glue or coating). In another preferred embodiment, previously cited, the knit fabric is formed, as polymeric material(s), of polymeric material P2, which, in the initial knit fabric and in the pre-consolidated preform, is then advantageously in the form of at least one yarn (of said material P2 or optionally in mixed form with the reinforcing material, or by wrapping or sheathing the reinforcement yarns) forming the stitches of the knit fabric and/or the weft yarns; and of the polymeric material P1, which, in the initial knit fabric, is then in the form of at least one yarn (of said material P1 or optionally mixed with the reinforcing material and/or the material P2, or by wrapping or sheathing the reinforcement yarns and/or of material P2) forming the stitches of the knit fabric and/or the weft yarns, and which, in the pre-consolidated preform, is then in molten form.

As previously indicated according to the invention, the polymeric material P1 forms less than 20% by volume of the knit fabric, and respectively of the preform made up of said knit fabric, and preferably its content is less than or equal to 15% by volume, in particular less than or equal to 10%, for example from 5 to 10%, of said knit fabric, and respectively of said preform, this polymeric material P1 being advantageously a minority in said knit fabric/said preform, whether considering its aforementioned low content level relative to the volume of the knit fabric, or its content level relative to the other polymeric material P2 when one is present, or its content level relative to that of the reinforcing material. The level of this material P1 within the composite formed from the preform is moreover advantageously less than or equal to 10% by volume, as indicated above. In the case where the material P2 that is to form the matrix of the composite already forms part of the knit fabric/preform and where the composite is advantageously obtained directly from the preform without adding more polymeric material, the content level of material P1 in the knit fabric/preform is also advantageously less than or equal to 10% by volume.

The material P2 intended to form the matrix or the essential part of the matrix of the composite product can be described as “main” in comparison with the other polymeric material P1, its content level by volume being greater (at least 2.5 times, preferably at least 5 times, greater) than that of the material P1 in the composite (and, where appropriate, in the knit fabric/preform if this material P2 is already present), its content level also being greater than that of the reinforcing material present. In particular, the content level of material P2 is advantageously at least 50% by volume, in particular at least 55% by volume, in the composite obtained from the preform. Even if the material P1 also forms part of the matrix forming the final composite, the material P2, whose content level is much greater, is considered to be the main material forming the matrix or the essential part of the matrix of the composite.

Preferably, the content level of total polymeric material (including at least the materials P1 and P2) in the composite product obtained according to the invention is preferably at least 55% by volume, in particular between 55 and 75% by volume, in particular between 60 and 70% by volume.

Polymeric material is understood to mean a material formed of macromolecule(s) or polymer(s) or copolymer(s), this material being formed either of a single type of molecules (having the same formula) or optionally of a mixture of molecules with different formulas (mixture of polymers). Advantageously, the polymeric materials P1, and if applicable P2 (or even other added polymeric materials as P3 previously mentioned) are chosen from thermoplastic materials, for example thermoplastic polymers of the polycarbonate (PC), polyetherimide (PEI), polypropylene (PP), polyamide (PA), poly(methyl methacrylate) (PMMA), poly(ethylene terephthalate) (PET), poly(phenylene sulfide) (PPS), polyetheretherketone (PEEK), polyetherketoneketone (PEKK), etc., the material P1 being chosen so as to have, if appropriate, a melting point lower than that of the material P2, the thermoplastic material being able to melt during the manufacture of the composite so as to form all or some of the matrix of said composite.

In particular, the polymeric material P1 is a thermoplastic material chosen for example from the following materials: polycarbonate, polyetherimide, polypropylene, polyamide, poly(methyl methacrylate). Its melting point is for example less than 225° C.

Advantageously, the polymeric material P2 is a thermoplastic material, having, where appropriate, in particular for applications (such as the manufacture of radomes) requiring the use of “high-temperature” fibers, a melting point greater than 250° C., in particular greater than 300° C. (thermoplastic with high melting point), this material then being chosen for example from the following materials: polyetheretherketone (PEEK), polyetherketoneketone (PEKK), etc., the material P2 and the reinforcing material being chosen respectively so that the material P2 has a melting point lower than the phase change temperature of the reinforcing material.

If necessary, when the material P2, or optionally another material P3, is added by impregnation or injection to the preform already pre-consolidated, this material P2 or this material P3 may optionally be a thermosetting material selected for example from polyurethane (PU), epoxy resins, cyanate ester, phenolic resins, polyester, etc.

Where appropriate and depending on the choice of the polymeric material, one and/or the other polymeric material used may comprise additives or fillers, which may be added to the step of formulating the polymer or, if appropriate, spinning the yarns, for example colored pigments or electrical charge dissipators, flame retardants, etc.

The content level of reinforcement/reinforcing material is preferably at least 25%, in particular at least 35%, by volume in the composite obtained from the preform, and, where appropriate, in the knit fabric or the preform when the latter is already formed from the two polymeric materials P1 and P2 and no polymeric material is added during the production of the composite, the content level of reinforcing material being, where appropriate, at least 80% by volume in the knit fabric or the preform when the latter is formed as polymeric material(s) only from the material P1. The reinforcing material may form one or more stitch yarns and/or form or may be for example in the form of unidirectional yarns integrated into the knit fabric, in particular weft yarns, this reinforcing material being able to form one or more yarns, alone or in combination with a polymeric material (mixed yarn(s)) present in the knit fabric. This reinforcing material, intended to form the frame of the composite (and consequently to not melt during the production of said composite), is chosen, for example, from the following materials: inorganic materials such as glass, quartz, alumina, carbon, basalt, metal or a metallic material; natural materials, such as flax, hemp, and optionally, depending on the choice of polymeric materials P1 and P2, from synthetic materials, plastic or thermally-resistant polymerics materials, such as aramids (para-; meta-, for example Kevlar®), polypropylene; polyetheretherketone (PEEK), polyetherketoneketone (PEKK), polyphenylene sulfide (PPS), etc.; its nature being chosen in particular as a function of its phase change temperature which must be greater than the melting or phase change point of the polymeric material(s) constituting the matrix of the final composite product.

The knit fabric according to the invention is obtained from at least one continuous yarn (in particular made of polymeric material and/or of reinforcing material), this yarn forming interlaced stitches arranged in successive rows. Weft yarns are also, where appropriate, added to the knit fabric during the knitting in the form of unidirectional yarns (by needles passing, for example, stitches or loops over the unidirectional yarns and holding them in place). Yarns other than stitch yarns (that is forming the stitches of the knit fabric) or weft yarns may also, if appropriate, be present (stitched seams or yarns, etc.).

The method of knitting the yarn(s) used may be a weft knitting method or a warp knitting method, and is preferably a weft knitting method.

In weft knitting, the yarn preferably follows the direction of the rows (weft direction, by analogy with fabric). Each loop of the same row is knitted one after the other, and each row is knitted one after the other, the stitches of a new row being received by the stitches of the lower row. A single yarn can make it possible to produce the entirety of the knit fabric, and each needle is controlled individually, making it possible to produce a complex 3D shape. In this technology, the substrate wherein the knitting needles slide is called a bed. A machine can use two beds, the base closest to the user making so-called “front” stitches, the second forming the “rear” stitches. It may be possible to knit on a single bed (single-bed knitting), alternating on two beds (also called single-bed knitting) or on two beds simultaneously (double-bed knitting), depending on the type of patterns or structure (hollow, thick, etc.) that is desired to be obtained.

In warp knitting, the yarn preferably follows the direction of the columns (warp direction, by analogy with fabric). All the loops of the same row are knitted at the same time, each row being knitted one after the other. One yarn is required per column of stitches, the needles being bonded in different groups. The knit fabrics produced by this method are generally flat.

The knitting may also be carried out by circular knitting or flat knitting machines. It is also possible to produce multi-walled knit fabrics by knitting several layers simultaneously by temporarily using needles for the additional walls.

Preferably according to the invention, the knit fabrics(s) used are obtained by a weft knitting technique, flat or circular, and preferably by a flat weft knitting technique, this technique making it possible to obtain complex 3D forms.

The yarn(s) used to make the knit may be (each) of the (monofilament) unitary type or formed from a bundle of filaments (multifilaments) such as for example a “roving” yarn (that is a set of parallel continuous filaments assembled without twisting) or a fiber yarn (that is a set of discontinuous short fibers assembled by twisting), etc. If appropriate, a yarn (stitch, weft or otherwise) may be an assembly of several yarns or filaments of different materials, this assembly being able to be made by twisting, wrapping, etc., or a yarn may also be a yarn of a material surrounded by another material (forming for example a sheath), this type of yarn incorporating two different materials being called mixed yarn. For example, it is possible to produce a yarn comprising polymeric material and reinforcing material, for example by assembling a reinforcing yarn and a thermoplastic yarn, by wrapping a yarn of a reinforcing material by a thermoplastic yarn, etc., the knitting of mixed yarns making it possible to easily obtain a dry preform containing both the reinforcement and the matrix. It is also possible to use one or more yarns comprising a first polymeric material, for example P1, and another polymeric material, for example P2, by assembling yarns, or else by wrapping, sheathing, the material P1 then constituting in practice the wrapping or sheathing material of the yarns of material P2; etc.

Generally, the reinforcing material is present in the knit fabric according to the invention in the form of reinforcing yarn(s) or mixed yarns, in particular in the form of stitch yarn(s) and/or in the form of unidirectional yarn(s), called UD yarn(s), inserted, in particular weft yarns, during the knitting, the stitch yarns including a reinforcing material ensuring, in particular, a better hold of the structure, while the unidirectional yarns including a reinforcing material make it possible to obtain the expected reinforcement (in particular mechanical). The knit fabric according to the invention may also comprise stitch yarn(s) and/or unidirectional yarn(s) and/or weft yarns, one or more yarns comprising at least one polymeric material (alone or as a mixture with another polymeric material or with a reinforcing material), as yarns produced from polymers (in particular thermoplastic polymers) lend themselves better to knitting (because they are not very sensitive to shearing, and having sufficient mechanical strength and flexibility). The one or more unidirectional yarns are preferentially 90° UD yarns, that is weft (arranged in the direction of the rows), but if appropriate one or more unidirectional yarns of the knit may be 0° UD yarns, that is arranged in the direction of the columns, perpendicular to the weft.

The knit may be obtained by simultaneously knitting one or more (for example from 2 to 10) stitch yarns and one or more (for example from 2 to 10) UD yarns, the stitch yarn(s) and the UD yarn(s) possibly comprising different materials. As already mentioned, a stitch yarn and/or a UD yarn may be formed of a material, and around this yarn can be twisted a yarn of another material, in particular thermoplastic, or this yarn can be surrounded by a sheath of said other material, for example obtained by passing the yarn(s) into a bath of molten thermoplastic material (with a lower melting point than the melting or phase change temperature of the material constituting the yarn), then by co-extruding the assembly. The stitch yarn(s) and/or UD yarn(s) may also be formed from an intimate mixture of filaments of different materials as already mentioned.

The different proportions of the different materials (polymeric(s) and reinforcement) in the knit fabric/preform are managed in particular by feeding the yarns, the diameter of the yarns, the choice of yarns, etc. It is also possible during the knitting to vary the nature, density, composition, etc., of the yarns in order to obtain different zones, nevertheless, in most cases, the preform and the composite product obtained according to the invention have a uniform, homogeneous composition without differentiated zones or with different functionalities. The preform advantageously consists of a single piece, without stitching and has in particular a three-dimensional structure similar to or adapted to the shape of the final composite product, this shape possibly being, for example, conical, cylindrical, etc.

The thickness of the knit fabric/preform (before or after pre-consolidation) is for example between 1 and 6 mm (without prejudice to its final thickness in the composite product). The knit may in particular have a surface weight or basis weight of 100 to 2500 g/m² and be made with densities from 3 to 6 rows/cm and from 2 to 4 columns/cm.

As previously indicated, the knit fabric/preform according to the invention is generally carried out by knitting at least one yarn of polymeric material P1 and/or P2 and/or reinforcing yarns, UD yarns being added in weft during the knitting (it is also possible to speak of simultaneous weft knitting of at least one stitch yarn and at least one unidirectional yarn). The knit fabric/preform may also be made by knitting at least one mixed yarn comprising polymeric material and reinforcing material.

The preform is then pre-consolidated by heating, in particular under pressure (at a pressure for example on the order of 1 to 20 bars), at a temperature of at least the melting temperature of the material P1, making said material viscous or liquid, the subsequent cooling of the preform making it possible to obtain a product having greater strength and rigidity than the initial preform (before pre-consolidation), and already having a shape close to the composite product to be obtained.

If necessary, when the polymeric material P2 intended to be part of or form the matrix of the composite product is already present in the knit fabric/preform and if the amount of this material provided by the yarns (stitch and/or UD) is sufficient, the composite product can then be directly obtained by heating the pre-consolidated preform, in particular under pressure (at a pressure for example on the order of 1 to 20 bars), without adding more polymeric material/resin by injection or infusion.

In another embodiment, when the knit fabric/preform comprises, as polymeric material(s), the material P1 only, the polymeric material P2 is then introduced into a mold as a liquid, as already mentioned, in particular during the production of the composite.

As already mentioned above, the method for producing the composite product from the initial knitting operation advantageously comprises two steps of treating and/or heating and/or melting thermoplastic materials, the first step (that of the pre-consolidation) taking place in particular at a temperature below the temperature of the second step (that of the final consolidation of the composite product).

The first heating step for pre-consolidating the preform (step c cited above) is carried out by depositing the preform in or on a mold, the mold being, where appropriate, closed and if appropriate under pressure (for example from 1 to 10 bars) and the mold being heated by heating, in particular of the induction or oven type, up to a temperature greater than or equal to the melting point T1 (this temperature preferably not exceeding 225° C., even 200° C., even 180° C. or even 160° C.), the temperature being maintained for a few minutes. After cooling, the pre-consolidated preform can be extracted or left if appropriate in the mold and/or on its substrate, for the consolidation step.

Alternatively, after deposition in the mold and/or on a substrate (such as a silicone bladder), the first heating step can be carried out by heating locally, if appropriate under pressure, as much as necessary, for example using an ultrasonic probe.

The mold used for the first heating can be formed from a rigid piece and a rigid or flexible counter-mold (for example in the form of a tarpaulin). If appropriate, the preform may have been draped beforehand or alternatively may be draped on a substrate or mandrel, in particular a deformable one, for example a silicone membrane or bladder, the preform/substrate assembly then being able to be deposited in a mold or locally heated for example by ultrasonic probes. If appropriate, the vacuum can be generated in the mold used.

The second step of heating or consolidating the pre-consolidated preform is then carried out in a mold (where appropriate formed of rigid or flexible part(s) as indicated above), this mold possibly, where appropriate, being the same as that used for the pre-consolidation or a different mold, in order to carry out the consolidation (according to the previously cited step g) and obtaining the desired composite product, the heating step in order to obtain this consolidation being, where appropriate, preceded by a step of injecting a polymeric material (for example the material P2) or carried out simultaneously with said injection step (step f).

According to a first embodiment, using in particular a three-component preform as previously described, the method for manufacturing the composite may not comprise a step (step f) of adding (in particular injection and/or infusion) another thermoplastic material, the preform being for example made by adapting the ratio of the thermoplastic materials and the reinforcing material to obtain the composite directly without adding more material. The pre-consolidated preform thus directly becomes the composite product after being placed in the mold and heated under pressure, before the product is removed from the mold and from its optional substrate.

According to another embodiment, a polymeric material intended to form or be part of the matrix of the composite is injected before or during the heating of step g). For this purpose, the pre-consolidated preform may for example be arranged (or “draped”) on the inner wall of a first, rigid, mold part. Next, according to the mold used, either a second rigid part, of the mold can be closed, then the polymeric material is injected under pressure into one or different points (operation, for example of the resin transfer or injection molding type), in particular to cover the entire surface of the preform, either a tarpaulin or a flexible membrane is arranged as counter-mold and the additional polymeric material is introduced by producing lower pressure at different points of said tarpaulin (for example, through vacuum infusion or infusion molding), in particular to cover the entire surface of the preform. The purpose of these various injection or lower-pressure points is to allow the flow and distribution of the polymeric material. This embodiment having a step of injection and/or infusion is used in particular when the preform is mostly made of reinforcing material, forming the frame, and of material P1.

The added polymeric material must be compatible with the materials already constituting the preform. This added material is in particular the polymeric material P2 when the preform has none when it comprises an insufficient proportion of it. If appropriate, another polymeric material P3 can also be added, in particular when the preform already comprises the materials P1 and P2, for example to form a more complex composite mixture and/or form overmoldings, etc.

Preferably, in the event of the addition (impregnation) of a polymeric material to the pre-consolidated preform (step f), use is made in particular of the transfer or injection of resin consisting of injecting the liquid resin (or polymeric material) in a closed mold, at one or more points, generally at low pressure (for example on the order of 1 to 4 bars), the injected resin migrating into the mold cavity and impregnating the entire structure (preform) deposited in the mold, the injection of resin being stopped when the mold impression is completely filled and the mold then being heated. The injection may sometimes be carried out at higher pressures (ranging for example up to 15 or 20 bars) for highly viscous resins. Alternatively, the infusion consists in placing the preform under vacuum, in a closed mold, which is impregnated subsequently with the arrival of polymeric material which is sucked by the vacuum created in the mold.

The treatment or consolidation (step g) according to the invention can be carried out in particular at a temperature above 250° C., in particular above 300° C., if appropriate at a pressure of 1 to 20 bars for example for a few tens of minutes. If appropriate, the vacuum can be used for step f) or g). In particular, the treatment and/or consolidation can be carried out by operating the compaction via the vacuum between a flexible membrane (silicone bladder) or a tarpaulin and a mold portion, or by pressurizing a flexible membrane or tarpaulin in order to press the preform against the walls of the mold, or by compaction by pulling the vacuum and injecting pressure inside the membrane, or by compaction/thermoforming into a rigid mold/counter-mold (of punch/die type), etc. The composite product obtained can then be removed from the mold, after cooling.

The present invention has made it possible to obtain finished products simply and economically without a connection (with good continuity of the aerodynamic profile), without loss or drop of material, and having good strength and reliability.

The pre-consolidated preform according to the invention can in particular be used to produce composite products in the fields of aeronautics (in particular for the manufacture of radomes), buildings, medical, furniture, automotive, etc. If appropriate, the preform may constitute only a specific area of a composite end product, but advantageously it makes it possible to directly obtain the complete composite product (then independently of the addition of other components and accessories).

The composite products obtained, formed from a matrix made of polymeric material reinforced with reinforcing fibers, include in particular between 55 and 75% by volume of polymeric material, and between 25 and 45% by volume of reinforcing fibers.

The following examples show in a non-limiting way the present invention.

### EXAMPLE 1

In the first example according to the invention, a preform formed from one or more tri-component knit fabrics, in a three-dimensional shape, already having all the materials necessary to obtain a radome-type composite product, by knitting simultaneously, for each knit fabric, by the weft knitting method:
as stitches, one or more mixed yarns formed of filaments of a first thermoplastic polymeric material P1, for example of polycarbonate or PMMA with a melting point T1, and filaments of a reinforcing material, for example glass or quartz,
as weft, one or more mixed unidirectional yarns formed of filaments of a reinforcing material, for example glass or quartz, and filaments of a second thermoplastic polymeric material P2, for example of PEEK of melting point T2.

The proportion of material P1 was 5% by volume, that of material P2 55% by volume and that of reinforcing material 40% by volume.

The knit fabrics(s) (optionally superposed) was/were then draped on a silicone bladder, this knit fabric(s) then forming a preform, and the assembly was deposited in a first steel mold for pre-consolidation of the preform. The mold was closed and the vacuum pulled and the mold was heated quickly by induction heating to a temperature greater than or equal to the melting temperature T1 but less than the melting temperature T2. The temperature was maintained for a few minutes. After cooling, the bladder was removed and the preform was extracted from the mold. This pre-consolidated preform obtained could be easily handled.

The pre-consolidated preform was then placed in a mold closed by a flexible counter-mold, then baked/consolidated/subjected to final consolidation treatment, by performing a vacuum heat treatment at a temperature greater than or equal to the melting temperature T2 and less than the phase change temperature of the reinforcing material T_{R} to give (after cooling) a composite product, without necessarily adding resin.

The composite, unitary and seamless product consisted of: 5% by volume of material P1, 55% by volume of material P2 and 40% by volume of reinforcing material.

### EXAMPLE 2

In this second example according to the invention, a preform is produced formed of one or more three-component knit fabrics, in three dimensions of conical shape, already having all the materials necessary to obtain a composite product of the radome type, by proceeding as in example 1, with the difference being that the initial knit(s) was/were carried out this time by knitting simultaneously, by the weft knitting method; and only as stitches, one or more mixed yarns formed of filaments of a thermoplastic polymeric material P2, for example of PEEK of melting point T2, and of filaments of a reinforcing material, for example of glass or quartz, this or these mixed yarns being wrapped with a thermoplastic material P1 with melting point T1, for example of polycarbonate or PMMA,

The proportion of material P1 was 5% by volume, that of material P2 55% by volume and that of reinforcing material 40% by volume.

The knit fabrics(s) were then draped on a mandrel for pre-consolidation of the preform formed of the knit fabrics. Using an ultrasound probe, manual heating under pressure has been applied locally as many times as necessary to obtain the desired pre-consolidation.

The pre-consolidated preform or the unitary and seamless composite product obtained by proceeding thereafter as in Example 1 were each constituted of: 5% by volume of material P1, 55% by volume of material P2 and 40% by volume of reinforcing material.

### EXAMPLE 3

In this third example according to the invention, a preform is produced formed of one or more two-component three-component knit fabrics of conical shape, knitting by the weft knitting method:
as stitches, one or more mixed yarns formed of filaments of a first thermoplastic polymeric material P1, for example of polycarbonate or PMMA with a melting point T1, and filaments of a reinforcing material, for example glass or quartz,
as weft, one or more unidirectional reinforcing yarns, for example glass or quartz yarn(s).

The proportion of material P1 was 11% by volume, that of reinforcing material 89% by volume in the knit fabric/in the preform.

The knit fabrics(s) was/were then draped on a silicone bladder, this knit fabric(s) (superposed if need be) thus forming a preform, and the assembly was deposited in a first steel mold for pre-consolidation of the preform(s). The mold was closed and the vacuum pulled and the mold was heated quickly by induction heating to a temperature greater than or equal to the melting temperature T1 but less than the phase change temperature T_{R} of the reinforcing material. The temperature was maintained for a few minutes. After cooling, the bladder was removed and the preform was extracted from the mold. The pre-consolidated preform obtained could be easily handled.

The pre-consolidated preform was then placed in a mold closed by a counter-mold, then a polymeric material P2 with a melting point T2, for example made of PEEK, was injected, and the preform was baked/consolidated/subjected to final consolidation treatment, by performing a vacuum heat treatment at a temperature above the melting temperature T2 and below the temperature T_{R} to provide (after cooling) a composite product.

The final composite, unitary and seamless product consisted of: 5% by volume of material P1, 55% by volume of material P2 and 40% by volume of reinforcing material.

### EXAMPLE 4

In this fourth example according to the invention, a preform is produced formed of one or more two-component three-component knit fabrics of conical shape, knitting by the weft knitting method:
as stitches, one or more mixed yarns formed of filaments of a first thermoplastic polymeric material P1, for example of polycarbonate with a melting point T1, and filaments of a reinforcing material, for example glass or quartz,
as weft, one or more unidirectional reinforcing yarns, for example glass or quartz yarn(s).

The proportion of material P1 was 10% by volume, that of reinforcing material 90% by volume in the knit fabric/in the preform.

The knit fabrics(s) were then draped on a bladder made of silicone, this knit fabric(s) (optionally superposed) thus forming a preform.

After deposition on the silicone bladder, the first heating step is carried out by heating locally using an ultrasonic probe.

The pre-consolidated preform draped on the silicone bladder is then placed in a mold, then a thermosetting polymeric material, for example made of an epoxy resin, was injected, and the preform was baked/consolidated/subjected to final consolidation treatment, by performing a vacuum heat treatment at a temperature necessary for curing the resin to give (after cooling) a composite product.

The final composite, unitary and seamless product consisted of: 5% by volume of material P1, 50% by volume of material P2 and 45% by volume of reinforcing material.

The pre-consolidated preforms according to the invention can in particular be used with advantage to produce new composite pieces intended in particular for aeronautics or to be used in the field of radio frequencies, in particular for the manufacture of radomes, etc.

1. A pre-consolidated preform produced by knitting, said preform being intended for the manufacture of a composite product, said pre-consolidated preform being formed of at least one knit fabric comprising at least one polymeric material and at least one yarn of at least one reinforcing material, said at least one knit fabric comprising a thermoplastic polymeric material P1 constituting less than 20% by volume of said at least one knit fabric or of said pre-consolidated preform and serving as adhesive in said pre-consolidated preform.

2. The pre-consolidated preform according to claim 1, wherein said at least one knit fabric or said pre-consolidated preform comprises at least one thermoplastic polymeric material P2 having a melting point T2, said at least one thermoplastic polymeric material P2 being intended to form a matrix of a composite product, the thermoplastic polymeric material P1 having a melting point T1 lower than the melting point T2, said at least one thermoplastic polymeric material P2 forming at least one yarn of said pre-consolidated preform.

3. The pre-consolidated preform according to claim 1, wherein said at least one knit fabric, or said pre-consolidated preform, comprises at least one yarn of at least one polymeric material, and at least one reinforcing yarn.

4. The pre-consolidated preform according to claim 1, wherein said at least one knit fabric is obtained by a flat weft knitting technique.

5. A method for manufacturing a pre-consolidated preform intended for manufacturing a composite product, said method comprising the following steps:
a) producing at least one preform formed of at least one knit fabric by knitting from at least one continuous yarn, said at least one knit fabric comprising one or more thermoplastic polymeric materials and comprising at least one yarn of at least one reinforcing material, a thermoplastic polymeric material P1 of the one or more thermoplastic polymeric materials having a lower melting point T1 representing less than 20% by volume of said at least one knit fabric or of said at least one preform,
b) depositing the at least one preform formed of at least said knit fabric in or on a mold or a substrate,
c) melting the thermoplastic polymeric material P1 with the lowest melting point T1 to a temperature greater than or equal to the melting point T1, said temperature being, where appropriate, in the event of the presence of another thermoplastic polymeric material of the one or more thermoplastic polymeric materials, intended to form a matrix of said composite product, less than the melting point of said other thermoplastic polymeric material, in order to allow only the melting of the thermoplastic polymeric material P1, and
d) cooling the at least one preform to obtain the pre-consolidated preform, the thermoplastic polymeric material P1 with the lowest melting point T1 then serving as adhesive.

6. The method for manufacturing a pre-consolidated preform according to claim 5, comprising as steps a) and c) the following steps:
a) producing at least one preform formed of at least one knit fabric by knitting from at least one continuous yarn, said at least one knit fabric comprising at least one thermoplastic polymeric material P2 having a melting point T2, and comprising at least one yarn of at least one reinforcing material, and comprising the at least one thermoplastic polymeric material P1, with a melting point T1 below the melting point T2, said thermoplastic polymeric material P1 representing less than 20% by volume of said at least one knit fabric; and
c) melting the thermoplastic polymeric material P1 at a temperature greater than or equal to T1 and less than T2.

7. The method according to claim 5, wherein said at least one knit fabric is obtained by a flat weft knitting technique.

8. A knit fabric or preform produced by knitting, intended for the manufacture of a composite product, comprising at least one thermoplastic polymeric material P2 having a melting point T2, said at least one thermoplastic polymeric material P2 being intended to form a matrix of a composite product, at least one polymeric material P1 having a melting point T1 lower than the melting point T2, intended to serve as adhesive, the at least one polymeric material P1 constituting less than 20% by volume of said knit fabric or of said preform, and at least one reinforcing material, the at least one polymeric material P1 forming one or more yarns of said knit fabric or of said preform.

9. The knit fabric or preform according to claim 8, further comprising at least one yarn of reinforcing material, the at least one polymeric material P1 and/or the at least one thermoplastic polymeric material P2 being in the form of at least one yarn and/or forming at least one mixed yarn with another of said materials and/or being in the form of wrapping or coating of at least one yarn of another of said materials.

10. A method of manufacturing a composite product, the method comprising:
depositing in a mold of at least one pre-consolidated preform formed by at least one knit fabric comprising one or more thermoplastic polymeric materials and at least one yarn of at least one reinforcing material, said at least one knit fabric or said at least one pre-consolidated preform comprising a thermoplastic polymeric material P1 with melting point T1 constituting less than 20% by volume of said at least one knit fabric or of said at least one pre-consolidated preform and serving as adhesive in said pre-consolidated preform, said at least one knit fabric optionally comprising at least one other polymeric material with a melting point greater than T1,
optionally impregnating with another polymeric material than the thermoplastic polymeric material P1,
treating or consolidating said pre-consolidated preform, impregnated where appropriate, having at least said thermoplastic polymeric material with melting point T1, another polymeric material intended to form a matrix of the composite product and at least one yarn of at least one reinforcing material, said treatment or said consolidation being carried out either, in the case where the other polymeric material is thermoplastic, at a temperature greater than or equal to the melting point of said other polymeric material, or, in the case where the other polymeric material is thermosetting, by curing said material, to obtain said composite product, and
cooling the composite product thus obtained.

11. The method for manufacturing a composite product according to claim 10, the wherein a content level of the thermoplastic polymeric material P1 in said composite product is less than 10% by volume of said composite product.

12. The method for manufacturing a composite product according to claim 10, wherein a polymeric material P2 having a melting point T2 greater than the melting point T1, and intended to form the matrix of said composite product, is added to the pre-consolidated preform during the production of the composite product.

13. A method for manufacturing a composite product, the method comprising the following steps:
a) producing at least one preform formed of at least one knit fabric by knitting from at least one continuous yarn, said at least one knit fabric comprising one or more thermoplastic polymeric materials and comprising at least one yarn of at least one reinforcing material, a thermoplastic polymeric material P1 of the one or more thermoplastic polymeric materials having a lower melting point T1 representing less than 20% by volume of said at least one knit fabric or of said at least one preform,
b) depositing the at least one preform formed of at least said at least one knit fabric in or on a mold or a substrate,
c) melting the thermoplastic polymeric material P1 with the lowest melting point T1 to a temperature greater than or equal to the melting point T1, said temperature being, where appropriate, in the event of the presence of another thermoplastic polymeric material of the one or more thermoplastic polymeric materials, less than the melting point of said other thermoplastic polymeric material, in order to allow only the melting of the thermoplastic polymeric material P1 with the lower melting point P1,
d) cooling the at least one preform to obtain the pre-consolidated preform, the thermoplastic polymeric material P1 with the lowest melting point T1 then serving as adhesive,
e) depositing at least said pre-consolidated preform into a mold,
f) optionally impregnating with another thermoplastic polymeric material than the thermoplastic polymeric material P1,
g) treating or consolidating said pre-consolidated preform, impregnated where appropriate, having said at least said thermoplastic polymeric material with melting point T1, another polymeric material intended to form a matrix of the composite product and at least one yarn of at least one reinforcing material, said treatment or said consolidation being carried out either, in the case where the other polymeric material is thermoplastic, at a temperature greater than or equal to the melting point of this other material, or, in the case where the other polymeric material is thermosetting, by curing said material, to obtain said composite product, and
h) cooling the composite product thus obtained.

14. The method according to claim 10, comprising first and second steps of treatment and/or heating and/or melting of thermoplastic materials, the first step being carried out at a temperature below the temperature of the second step.

15. The method according to claim 14, wherein the first heating step, or step c, is carried out, after optional draping of the preform on a flexible substrate and deposition of the assembly in a mold, by setting the mold to heat or by heating the preform locally to a temperature greater than or equal to the melting point T1.

16. The method according to claim 14, wherein the second heating step, or step g, is carried out at a temperature above 250° C.

17. A composite product obtained by the method according to claim 10, said composite product comprising at least one polymeric material P2, forming the matrix of said composite product, and comprising at least one yarn of at least one reinforcing material, and at least one polymeric material P1 representing less than 10% by volume of said composite product.

18. The method for manufacturing a composite product according to claim 12, wherein the polymeric material P2 is added to the pre-consolidated preform by impregnating said pre-consolidated preform or said at least one knit fabric with said polymeric material P2.

19. The method according to claim 15, wherein the flexible substrate is a silicone bladder.

20. The composite product according to claim 17, wherein the composite product is a piece intended for aeronautics or to be used in the radiofrequency field.
